(19) United States
(12) Patent Application Publication
(10) Pub. No.: US 2003/0023752 A1
(43) Pub. Date: Jan. 30, 2003

(54) Pluggable URL providers in a J2EE server

(75) Inventors: Leigh Allen Williamson, Austin, TX (US); Roger L. Cundiff JR., Austin, TX (US)

Correspondence Address: Robert H. Frantz, P.O. Box 23324, Oklahoma City, OK, 73123-2334, US

(73) Assignee: International Business Machines Corporation, Armonk, NY (US)

(21) Appl. No.: 09/902,694

(22) Filed: Jul. 12, 2001

(51) Int. Cl. G06F 15/16

(52) U.S. Cl. 709/245; 709/242; 709/222

(57) ABSTRACT

An enhanced enterprise application server which can support the use of any URL resource, regardless of the protocol for that URL and regardless of a default set of URL resource protocols provided with the unenhanced application server. New URLs and URL resources are created, and new URL providers are installed on each application server. References to the new URL objects are bound into the namespace of the server. New URL providers are registered; a default URL stream handler factory is overridden and replaced by a new URL stream hander factory. Subsequently, an application program may lookup a resource by name, in response to which a naming service returns a URL for one of the new URL resources, so that the application can then use the new URL resource as needed. Therefore, a broader set of applications can be integrated and served by the so-equipped application server product.

### BACKGROUND OF THE INVENTION

1. Field of the Invention

This invention relates to the arts of enterprise application servers, and especially to the technologies of extensible resource libraries available to applications being executed by an application server.

2. Description of the Related Art

Application servers are prevalent throughout business, scientific and entertainment industries, as they provide everything from “back office” automation such as billing, accounting, and order entry functions; to customer interface functions such as allowing clients to place orders directly into a suppliers computers, reserve products or services, and manage their own accounts; to online entertainment and gaming systems which allow customers to access games and useful information in trade for being presented marketing information, banner advertisements, and sponsored hyperlinks. As such, application servers may communicate with client computers via a corporate intranet or private computer network, via a publicly accessible network such as the Internet, or both.

An application server is a server computer and one or more programs that provides the logic for an online or automated application, and is typically part of a larger, distributed computing system. Application servers are often modeled as a component of a three-tier system having a graphical user interface (GUI) server, an application or business logic server, and a database server.

One such application server is the WebSphere [TM] product from International Business Machines. WebSphere is available for a number of platforms, including computers from personal computers to high-end “main frames” running operating systems ranging from Microsoft Windows NT [TM], to IBM's AIX [TM], to the open source Linux.

A WebSphere application server provides an environment for open distributed computing. Users and processes on a wide variety of platforms can interact by using the facilities provided by WebSphere. A common method of organizing software to run on distributed systems is to separate functionality into two parts: clients and servers. A client is system that runs one or more programs and uses services provided by server systems, the server systems themselves running one or more server programs. The client system makes a request for a service to the server system, and a server system performs that service on behalf of the client system.

For many applications, the application server cooperates with or even incorporates a Web server, such as a hyper text transfer protocol (HTTP) server, for communicating with web browser computers as the client computers. In such an instance, the application server is often referred to as a “Web Application Server” or “Web Server”. In this configuration, a web browser client allows the user interface to be implemented in the well-known hyper text markup language (HTML). A typical web server provides one or more well-known methods to forward a request to an application server and to return information to the user, including: Common Gateway Interface (CGI), Microsoft's [TM] Active Server Pages (ASP), Java Server Pages (JSP), or even the more advanced Common Object Request Broker Architecture (CORBA).

Server system functionality usually includes “resource management”, through which a server synchronizes and manages access to one or more “resources” such as databases or database servers. Client requests are received by the server system, processed, and appropriate accesses to the resources are made. A response to the client system is then created and transmitted to the client system. This general model is applicable to many server paradigms, including online banking, order entry and tracking, e-commerce, and even electronic mail processing.

Client programs typically handle user interactions, such as presenting drop down lists, menus, pages of information, and “playing” animated graphics or audio. Client programs also typically include functionality to request data or to initiate some data modification on behalf of a user by the server system. For example, a client system can display a form on which a user can enter orders for a product. The client may then transmit this order information to a server system, which checks a product database and performs tasks needed for billing and shipping.

In many cases, a single server system is used by multiple clients simultaneously. For example, dozens or hundreds of clients can interact with a handful of servers that control database access.

A common model of client/server systems, shown in FIG. 1, uses three tiers: one or more client systems (10) that interact with the users, one or more application servers (12) that contain the business logic of the applications provided to the users, and one or more resource managers (13) and associated data stores (14) that store and retrieve data.

In this model, the network (11) between the clients and the servers (12) may be a corporate local area network (LAN) or intranet, such as in the case of a corporate application server which is not publicly accessible. In this case, the client systems may be provided with any specific software programs, such as IBM's Lotus Notes, which cooperates with the application server programs. For applications which are intended for widespread use or public use, the network (11) may be the Internet, the client computers may be equipped with appropriate web browser software such as Netscape's Navigator [TM], and the application servers are equipped with appropriate HTTP server software, such as the IBM WebSphere product.

The interfaces between the servers (12) and the resource manager(s) (13) may be LAN, Internet, or a proprietary interface. The data stores and databases (14) may be physically housed in separate platforms, or may be integrated to the resource managers (13). In some cases, the resource managers, databases, and application servers may be software processes all executing on the same platform, too.

Using this arrangement of systems and functionality, the client systems (10) are isolated from having to know anything about the actual resource managers (13) and resources (14). It needs only to have the capability to communicate and interact with the server systems (12), and does not have to have specific capabilities or software to communicate directly with the resources (14). This allows a service provider to make changes to the resource tier of the arrangement without requiring changes to the client systems.

For example, a bank may install a new system of databases for online loan processing. With this arrangement, an HTML web browser client computer may be enabled to access these new databases and online loan services through changes to the server computer programs only, without need for changes to the client computer. Since most servers are relatively few in number compared the to vast number of client computers (and potential client computers) they server, this is an significant advantage of the arrangement. Additionally, the resource manager can be assigned the task of security and access control such that users requesting secure data from the resources may be allowed or denied access to that data.

Because there is often need to rapidly develop and deploy in the market place new business applications and enhancements to existing business applications, there are several “standards” with which most application servers are compatible. This allows the business application program developers to work within programming and computing environments in which they are familiar, regardless of which specific application server platform will eventually execute the application.

In recent years, Sun Microsystems' Java [TM] programming language and programming environment have gained widespread acceptance and use due to its portability between a wide variety of platforms, and due to its object oriented methodology.

Java client programs, or “applets”, can be delivered by a server computer to a client computer using common protocols such as HTTP, with links to retrieve the applets embedded in forms or web pages. Server programs are often implemented as a collection of “servelets”.

Recently, Sun Microsystems has extended the definition of the general Java environment to include more enterprise and distributed computing functionality, called Java platform Version 2 Enterprise Edition (J2EE). J2EE supports the 3-tiered model of client-server-resource manager, as previously described. The J2EE platform is a platform for hosting J2EE applications specified as a set of required application program interfaces (APIs) and policies. The J2EE specifications and documentation are readily available from Sun Microsystems, and J2EE is well-known by those skilled in the art.

The J2EE specification mandates that application server products support the use of universal resource locator (URL) resources by the applications that run in the server. URLs can have many different protocols besides the common ones, such as HTTP, FTP, file, and mailto, that are supported by the default code that is supplied with the Java Virtual Machine (JVM) libraries.

However, the J2EE specification does not state the limits of URL protocol support, and only the default URL protocols are tested for specification compliance.

There are several examples of non-default URL protocols that applications may need to use, however. One such example is the Network News Transfer Protocol (NNTP) for Usenet newsgroups.

Therefore, there is a need in the art for a system and method which enables an application server to support the use of any URL, regardless of the protocol for that URL, especially with respect to standard enterprise platforms such as J2EE. There is a further need in the art for this system and method to allow for the extension of the application server with external URL handling code for any protocol desired.

### BRIEF DESCRIPTION OF THE DRAWINGS

The following detailed description when taken in conjunction with the figures presented herein provide a complete disclosure of the invention.

FIG. 1 shows the well known three-tiered model of client-server arrangements in enterprise computing.

FIG. 2 depicts the J2EE organization of business and user interface functions.

FIG. 3 illustrates the logical flow of the invention for creating or configuring an extension to the default application server URL resources.

FIG. 4 sets forth the logical process of using a new or extension resource during application execution.

### SUMMARY OF THE INVENTION

This system and method of the invention define how an application server can support the use of any URL, regardless of the protocol for that URL. It allows for the extension of the application server with external URL handling code for any protocol desired. The invention allows an application server to be more flexible and useful for Application Integration because the use of URL resources is not limited to the default resources supported in the enterprise platform, such as the limitations found in the present J2EE JVM. Therefore, a broader set of applications can be integrated and served by the so-equipped application server product.

New URLs are created, and new URL providers are installed on each application server node. New URL resources are created, as well, and references to the new URL objects are bound into the global namespace of the server.

During configuration of the application server, the new URL providers are registered and the default URL stream handler factory is overridden and replaced by a new URL stream hander factory. During runtime of an application program, the application program can perform a lookup by resource name, which is handled by an application server naming service and answered with a URL for one of the new URL resources. Then, the application server may use the new URL resource as needed.

### DETAILED DESCRIPTION OF THE INVENTION

The present invention provides a system and method for an application server to support the use of any URL, regardless of the protocol for that URL. It allows for the extension of the application server with external URL handling code for any protocol desired. The invention is preferably realized as a combination of “standard” or well-known software, combined with an implementation of the method of the invention in software, all executing on a commonly available computing platform.

Use of this invention in a “standard” application server makes the improved application server more flexible and useful for Application Integration because the use of URL resources is not limited to the default ones supported in the enterprise platform, such as the limitations found in the present J2EE JVM. Therefore, a broader set of applications can be integrated and served by the so-equipped application server product.

In the preferred embodiment, the “standard” software used is an IBM WebSphere Application Server, release 4.0 (or higher), running on a personal computer platform running Microsoft's Windows NT [TM] operating system. Those skilled in the art will readily recognize that many alternate computing platforms, operating systems, and enterprise application server suites may be used with the present invention without departing from the scope of the invention, such as UNIX, Linux, IBM's AIX [TM], Sun Microsystems' Solaris, or Hewlet-Packard's HP-UX operating systems running on common computing platforms such as personal computers, AS/400's, mid-range servers, System 360 computers, etc.

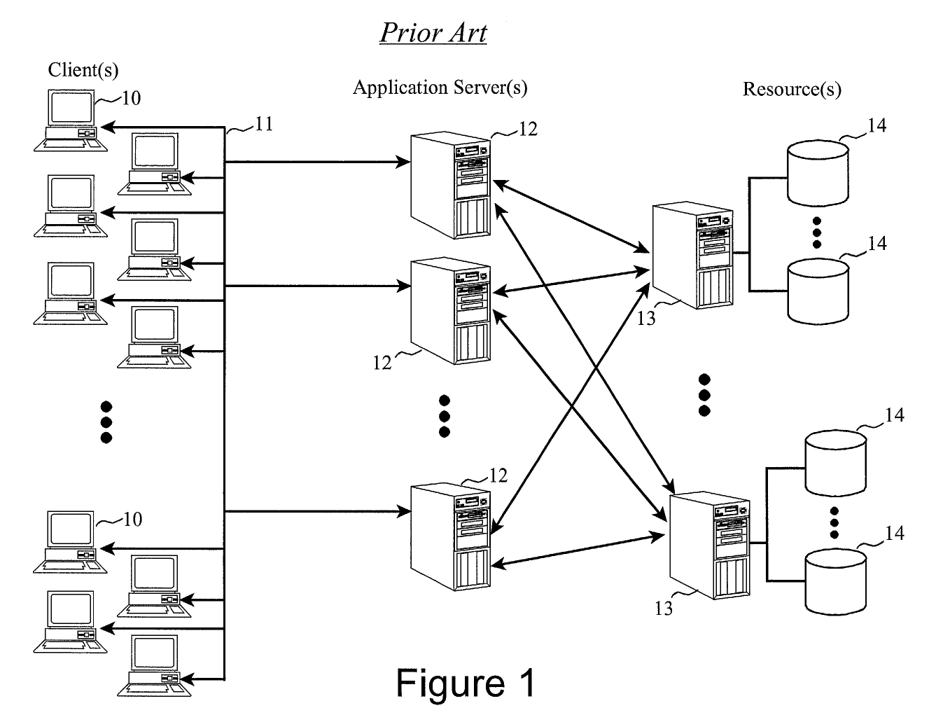

The invention allows the default resource objects on an application server, and especially a J2EE-compliant application server, to be extended to include other resource objects which are accessible to and usable by Java Version 2 Enterprise Edition (J2EE) Enterprise JavaBeans (EJB), servlets or other application programs. The primary benefit of the J2EE application model is in the middle tier of the model as described in FIG. 1.

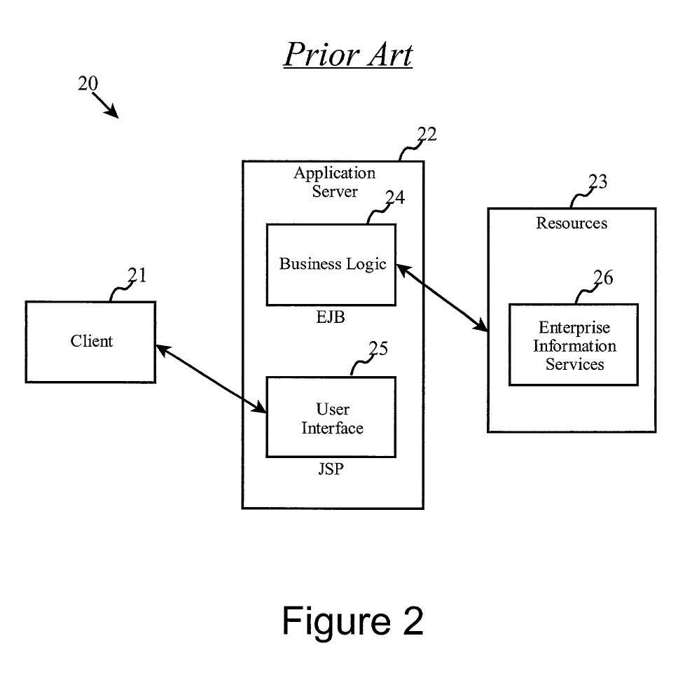

In the well-known J2EE platform, middle-tier business functions are implemented as Enterprise JavaBean components (EJB), as shown in FIG. 2. This organization allows the user interface (25) functions to be separated from the business logic (24) on the application server (22). The business logic (24) interfaces to the resources (23) such as a resource manager, and the user interface (25) interfaces to the clients (21). This achieves a realization of the idealized model of FIG. 1, with separation and isolation of client interface methods from resource interface methods. The method of the invention supports access to URL resources by application programs such as EJBs which have different protocols than the default protocols supported by the JVM in any J2EE-compliant web server, but especially within the WebSphere server as in the preferred embodiment.

The enterprise beans component model allows service developers to focus on the business logic and to let the application server handle the complexities of delivering a reliable, scalable service. Thus, EJB components implement the business logic in the middle tier of the model of FIG. 1.

Returning to FIG. 2, the user interface (25) presents middle-tier functions to the client tier as Internet-style services, usually through JavaServer Pages technology and servlets. Using JSP technology makes it easy for user interface developers to present dynamically generated pages to any client equipped with an Internet browser. Servlets give more sophisticated developers of Java-based applications the ability to implement dynamic presentations completely in the Java programming language. JSP, servlets, HTML, HTTP, and ASP are well-known in the art.

The remainder of this disclosure presents the method of the invention in a manner suitable for realization as a process executed in part by a system administrator, and in part by the server software. It will be recognized by those skilled in the art that other equivalent implementations may be possible, using other programming methodologies, server suites, and computing platforms, as well as complete automation of the method, without departing from the scope of the invention.

In the J2EE platform, the applications link to their needed resources by indirection through Java Naming Directory Interface (JNDI) lookup. As such, the applications themselves don't contain any knowledge or details regarding their linked resources, other than the fact that the resources can be instantiated as instances of the appropriate resource type.

Essentially, during runtime, the application performs a “lookup” on a specified string which contains the name of the resource, but does not include information regarding the resource configuration.

The application server codeflow receives the lookup, retrieves one of the requested resources, and returns it to the requesting application. The application casts it as a URL, and then begins to use the resource by establishing a connection to it using the standard Java APIs. The resource may not be co-located with the application, but may be remotely invoked or used over a computer network in some instances. This process is part of the standard, well-known J2EE platform.

However, the J2EE specification requires application servers to support indirect lookup of URL resources, but does not provide a method for doing this in a broad or extensible manner. If a system does not extend the standard set of URL resources provided by the J2EE JVM, the application programs' abilities are limited to the default abilities in the JVM resource libraries, such as HTTP, FTP, “file:” and “mailto:”.

So, the following method of the invention extends the ability to support any URL resource with any protocol beyond the default protocols, whether that be a proprietary protocol or another standard protocol which is not included in the JVM library, all of this being done through the use of indirect lookup by URL in compliance with the J2EE specification. This allows users of an application server to incorporate their own libraries or other third-party libraries as needed without adopting a proprietary scheme for use of the new resource, and without causing the system to be non-compliant with the J2EE specification.

A key aspect of the method is the capture of certain information about the new or extension library such that the system administration for the application server can load the new library and assign requested resources to requesting applications during runtime.

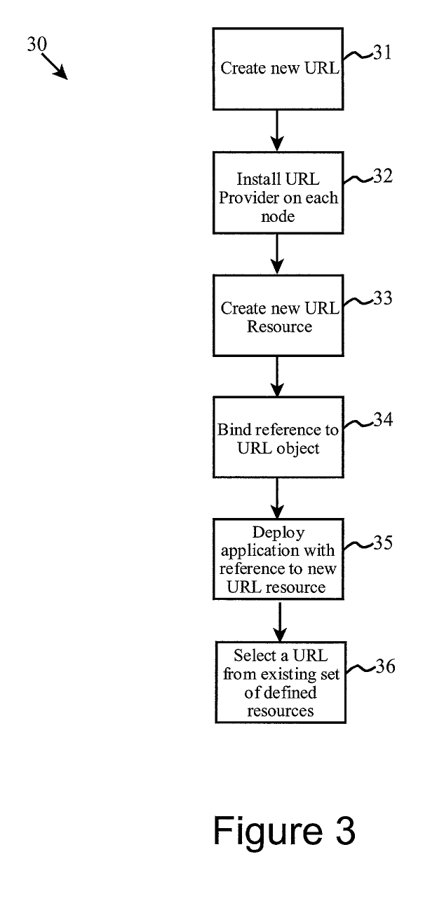

FIG. 3 depicts the logical flow of the invention for creating (30) or configuring an extension to the application server URL resources. First, a services developer creates (31) a new URL Provider, and specifies the name, description, supported protocol, and stream handler class name.

Next, the new URL Provider is installed (32) on each desired node, and the classpath on each node (i.e., location of the Provider's jar file on the node) is specified.

Then, the services developer creates (33) a new URL resource giving the name, description, and URL specification string. According to the preferred embodiment, this may be done in the WebSphere administration domain. The administration system binds (34) a reference to the URL object into the global namespace at “url/<name>”, where <name> is the name of the new URL resource. While “url/<name>” is the default location of the method, this can be overridden by the system administrator.

Now, a services developer or system administrator may deploy onto application servers an application which contains a reference to the new or extension URL resource.

The service developer then selects (36) a URL from the existing set of defined resources to bind to the application's reference to the new resource.

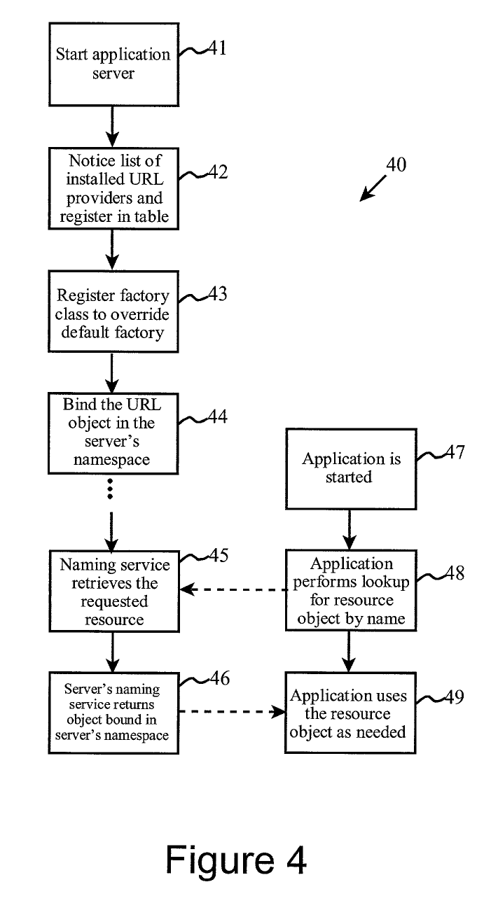

Turning to FIG. 4, the process of using (40) the new resource during application execution is shown. First, of course, the application server with the application program is started (41). Then, the application server notices (42) the list of installed URL Providers on its node, as well as the set of URL resources used by applications installed on it. The application server registers (42) each URL Provider in a table of (protocol, streamHandlerClass) pairs that the server's streamHandlerFactory class uses to return the appropriate stream handler for a given protocol. The application server also calls java.net.URL.setURLStreamHandlerFactory() to register (43) the extension factory class in order to override the default URLStreamHandler factory provided by the base Java runtime.

Further during application server initialization, the server configuration object binds (44) the URL object into the application server's java:comp namespace.

After the application is started (47), an application program such as an EJB performs (48) a lookup (“java:comp/env/url/<logical name>”) for which the naming service returns (46) the URL object which was earlier bound (44) in the server's namespace. The application then may use (49) the resource via the URL as needed, thereby meeting the J2EE requirement while also allowing the default set of resources to be extended and/or overridden completely.

It will be recognized by those skilled in the art that the foregoing detailed description is given in terms of a preferred embodiment, and that many variations and modifications from the preferred embodiment may be made without departing from the spirit and scope of the invention, such as us of alternate programming methodologies and languages, operating systems, computing platforms, and enterprise application server suites. As such, the scope of the present invention should be determined by the following claims.

What is claimed is:

1. A method of providing an extension to a default set of resource functions in an enterprise application server, said application server having a default Universal Resource Locator (URL) stream handler factory class, said method comprising the steps of:
providing one or more extension URL providers on an application server, said extension URL providers each having a specified name, description, supported protocol and stream handler class name, and classpath;
binding a reference to one or more extension URL objects into a global namespace on said application server;
registering said extension URL providers to be used by an application program in a table of parameter sets having a protocol identifier and a stream handler class identifier;
overriding said default URL stream handler to enable an extension URL stream handler; and
binding one or more extension URL objects into an application server namespace such that said registered extension URL providers and extension URL objects are available to and for use by an application program through an application server naming service.

2. The method as set forth in claim 1 further comprising the steps of:
executing a computer instruction by an application program to lookup a resource object by a resource name via an application server naming service; and
retrieving a bound and registered extension URL object according to said resource name.

3. The method as set forth in claim 1 wherein said step of providing one or more extension URL providers includes specifying a classpath as a location of said extension URL provider's jar file on the application server.

4. The method as set forth in claim 1 wherein said step of overriding said default URL stream handler is performed by executing a Java function to set the application server's URL Stream Handler Factory to said extension URL stream handler.

5. A computer readable medium encoded with software for providing an extension to a default set of resource functions in an enterprise application server, said application server having a default Universal Resource Locator (URL) stream handler factory class, said software when executed by an application server to perform the following steps:
provide one or more extension URL providers on an application server, said extension URL providers each having a specified name, description, supported protocol and stream handler class name, and classpath;
bind a reference to one or more extension URL objects into a global namespace on said application server;
register said extension URL providers to be used by an application program in a table of parameter sets having a protocol identifier and a stream handler class identifier;
override said default URL stream handler to enable an extension URL stream handler; and
bind one or more extension URL objects into an application server namespace such that said registered extension URL providers and extension URL objects are available to and for use by an application program through an application server naming service.

6. The computer-readable medium as set forth in claim 5 further comprising software for performing the steps of:
executing a computer instruction by an application program to lookup a resource object by a resource name via an application server naming service; and
retrieving a bound and registered extension URL object according to said resource name.

7. The computer-readable medium as set forth in claim 5 wherein said software for providing one or more extension URL providers includes software for specifying a classpath as a location of said extension URL provider's jar file on the application server.

8. The computer-readable medium as set forth in claim 5 wherein said software for overriding said default URL stream handler is comprises software for executing a Java function to set the application server's URL Stream Handler Factory to said extension URL stream handler.

9. An extensible Universal Resource Locator (URL) resource system for an enterprise application server, said enterprise application server having a default set of resource functions in an enterprise application server and a default Universal Resource Locator (URL) stream handler factory class, said extensible URL resource system comprising:
one or more extension URL providers on an application server, said extension URL providers each having a specified name, description, supported protocol and stream handler class name, and classpath;
a registry of said URL providers comprising a table having a parameter set for each URL provider, said parameter set comprising a protocol identifier and a stream handler class identifier;
a default URL stream handler factory overrider adapted to replace said default URL stream handler factory with a extension URL stream handler factory; and
one or more bound references for of one or more URL objects into an application server namespace such that said registered URL providers and URL objects are available to an application program via an application server naming service.

10. The extensible Universal Resource Locator (URL) resource system as set forth in claim 9 further comprising:
a lookup facility for looking up a resource object by a resource name for use by an application program; and
a URL object retriever adapted to retrieve a bound and registered URL object according to said looked-up resource name.

11. The extensible Universal Resource Locator (URL) resource system as set forth in claim 9 wherein said extension URL providers include a classpath specifying a location of said extension URL provider's jar file on the application server.

12. The extensible Universal Resource Locator (URL) resource system as set forth in claim 9 wherein said default URL stream handler overrider comprises a Java function to set the application server's URL Stream Handler Factory to said extension URL stream handler.
